(19) United States
(12) Patent Application Publication
(10) Pub. No.: US 2026/0167129 A1
(43) Pub. Date: Jun. 18, 2026

(54) Apparatus for Controlling Vehicle and Method Thereof

(71) Applicants: Hyundai Motor Company, Seoul (KR); Kia Corporation, Seoul (KR)

(72) Inventors: Young Kwon Jang, Hwaseong-Si (KR); Yong Min Kwon, Hwaseong-Si (KR)

(21) Appl. No.: 19/229,231

(22) Filed: Jun. 5, 2025

(30) Foreign Application Priority Data
Dec. 17, 2024 (KR) 10-2024-0188840

(51) Int. Cl. B60R 16/023; B60R 16/037; G06F 8/65

(52) U.S. Cl. CPC B60R 16/0231; B60R 16/037; G06F 8/65

(57) ABSTRACT

Disclosed are an apparatus for controlling a vehicle and a method thereof. The apparatus may receive, via a wireless communication with a vehicle key associated with the vehicle, at least one input signal. The at least one input signal may be generated based on a button of the vehicle key being activated. The apparatus may determine a plurality of input signal patterns based on at least one of: a number of times that the at least one input signal is received, an interval of the at least one input signal, a duration of the at least one input signal, or a time at which the at least one input signal is received. The apparatus may control, based on the plurality of input signal patterns, the vehicle.

### CROSS-REFERENCE TO RELATED APPLICATION

This application claims the benefit of priority to Korean Patent Application No. 10-2024-0188840, filed in the Korean Intellectual Property Office on Dec. 17, 2024, the entire contents of which are incorporated herein by reference.

### TECHNICAL FIELD

The present disclosure relates to an apparatus for controlling a vehicle and a method thereof, and more particularly, to a technology for controlling a vehicle by a smart key.

### BACKGROUND

A smart key may remotely control main functions of a vehicle. For example, various functions of a vehicle, such as locking a door of the vehicle, opening a trunk, remote starting, and the like may be performed with press of a button on a smart key. However, a smart key may not sufficiently reflect the user's needs due to its structural and functional limitations, and there are various problems.

### SUMMARY

The present disclosure has been made to solve the problems existing in at least some implementations while advantages achieved by these implementations are maintained intact.

One aspect of the present disclosure provides an apparatus for controlling a vehicle and a method thereof capable of eliminating the constraints of the physical space of a button and reducing the size and weight of a smart key by performing various functions of a vehicle with a single multi-function button of the smart key.

Another aspect of the present disclosure provides an apparatus for controlling a vehicle and a method thereof capable of expanding or changing the functions of the multi-function button through over-the-air (OTA) updates.

Still another aspect of the present disclosure provides an apparatus for controlling a vehicle and a method thereof capable of improving the user experience and marketability by freely selecting or setting the function of the multi-function button according to the user's preference.

Still another aspect of the present disclosure provides an apparatus for controlling a vehicle and a method thereof capable of effectively increasing the number of functions that are executed by the multi-function button by setting different functions to be performed depending on various manners in which the multi-function button is operated.

Still another aspect of the present disclosure provides an apparatus for controlling a vehicle and a method thereof capable of improving the convenience of the user by setting or changing the functions of the multi-function button through the terminal of the user.

The technical problems to be solved by the present disclosure are not limited to the aforementioned problems, and any other technical problems not mentioned herein will be clearly understood from the following description by those skilled in the art to which the present disclosure pertains.

According to one or more example embodiments of the present disclosure, an apparatus of a vehicle may include: a processor; and a memory storing at least one instruction. The at least one instruction may be configured, when executed by the processor communicating with the memory, to cause the apparatus to receive, via a wireless communication with a vehicle key associated with the vehicle, at least one input signal. The at least one input signal may be generated based on a button of the vehicle key being activated. The at least one instruction may be configured, when executed by the processor communicating with the memory, to further cause the apparatus to determine a plurality of input signal patterns based on at least one of: a number of times that the at least one input signal is received, an interval of the at least one input signal, a duration of the at least one input signal, or a time at which the at least one input signal is received. The at least one instruction may be configured, when executed by the processor communicating with the memory, to further cause the apparatus to control, based on the plurality of input signal patterns, the vehicle.

The at least one instruction may be configured, when executed by the processor communicating with the memory, to further cause the apparatus to assign each of a plurality of functions of the vehicle to a corresponding one of the plurality of input signal patterns.

The at least one instruction may be configured, when executed by the processor communicating with the memory, to further cause the apparatus to: receive assignment information from at least one of: a user interface of the vehicle, a user terminal associated with the vehicle, an infotainment system of the vehicle, or an external server communicating with the vehicle; and perform, based on the assignment information, at least one of: assigning each of a plurality of functions of the vehicle to a corresponding one of the plurality of input signal patterns; or reassigning the plurality of functions of the vehicle.

The at least one instruction may be configured, when executed by the processor communicating with the memory, to cause the apparatus to receive the assignment information by: receiving the assignment information through at least one of: a communication interface configured to wirelessly relay data on the vehicle, or a gateway configured to route the data on the vehicle.

The at least one instruction may be configured, when executed by the processor communicating with the memory, to cause the apparatus to control the vehicle by: activating or deactivating an assignment of a first function of the vehicle to a first input signal pattern of the plurality of input signal patterns; and performing one of: executing, based on the assignment of the first function to the first input signal pattern being activated, the first function; or not executing, based on the assignment of the first function to the first input signal pattern being deactivated, the first function.

The at least one instruction may be configured, when executed by the processor communicating with the memory, to cause the apparatus to control the vehicle by: controlling, based on the plurality of input signal patterns, a function of the vehicle; and updating, via a software update, a type of the function of the vehicle.

The at least one instruction may be configured, when executed by the processor communicating with the memory, to cause the apparatus to control the vehicle by: executing, based on determining an input signal pattern of the plurality of input signal patterns at a first time, a function, of the vehicle, that is assigned to the input signal pattern; and returning, based on determining the input signal pattern at a second time after the first time and after the function is executed, the vehicle to a state before executing the function.

The at least one instruction may be configured, when executed by the processor communicating with the memory, to cause the apparatus to control the vehicle by: controlling, based on the plurality of input signal patterns, at least one of: a door of the vehicle, an ignition of the vehicle, an air conditioning system of the vehicle, lighting of the vehicle, security of the vehicle, parking of the vehicle, a seat of the vehicle, an alarm of the vehicle, charging of the vehicle, or a multimedia system of the vehicle.

The at least one instruction may be configured, when executed by the processor communicating with the memory, to cause the apparatus to determine the plurality of input signal patterns by: identifying different input signal patterns based on the number of times that the at least one input signal is repeated within a predetermined time period.

The at least one instruction may be configured, when executed by the processor communicating with the memory, to cause the apparatus to control the vehicle by: controlling, with a predetermined priority based on identifying overlapping signal patterns among the plurality of input signal patterns, the vehicle.

According to one or more example embodiments of the present disclosure, a method performed by an apparatus of a vehicle may include: receiving, via a wireless communication with a vehicle key associated with the vehicle, at least one input signal; determining a plurality of input signal patterns based on at least one of a number of times that the at least one input signal is received, an interval of the at least one input signal, a duration of the at least one input signal, or a time at which the at least one input signal is received; and controlling, based on the plurality of input signal patterns, the vehicle. The at least one input signal may be generated based on a button of the vehicle key being activated.

The method may further include: assigning each of a plurality of functions of the vehicle to a corresponding one of the plurality of input signal patterns.

The method may further include: receiving assignment information from at least one of: a user interface of the vehicle, a user terminal associated with the vehicle, an infotainment system of the vehicle, or an external server communicating with the vehicle; and performing, based on the assignment information, at least one of: assigning each of a plurality of functions of the vehicle to a corresponding one of the plurality of input signal patterns; or reassigning the plurality of functions of the vehicle.

Receiving the assignment information may include: receiving the assignment information through at least one of: a communication interface configured to wirelessly relay data on the vehicle, or a gateway configured to route the data on the vehicle.

Controlling the vehicle may include: activating or deactivating an assignment of a first function of the vehicle to a first input signal pattern of the plurality of input signal patterns; and performing one of: executing, based on the assignment of the first function to the first input signal pattern being activated, the first function; or not executing, based on the assignment of the first function to the first input signal pattern being deactivated, the first function.

Controlling the vehicle may include: controlling, based on the plurality of input signal patterns, a function of the vehicle; and updating, via a software update, a type of the function of the vehicle.

Controlling the vehicle may include: executing, based on determining an input signal pattern of the plurality of input signal patterns at a first time, a function, of the vehicle, that is assigned to the input signal pattern; and returning, based on determining the input signal pattern at a second time after the first time and after the function is executed, the vehicle to a state before executing the function.

Controlling the vehicle may include: controlling, based on the plurality of input signal patterns, at least one of: a door of the vehicle, an ignition of the vehicle, an air conditioning system of the vehicle, lighting of the vehicle, security of the vehicle, parking of the vehicle, a seat of the vehicle, an alarm of the vehicle, charging of the vehicle, or a multimedia system of the vehicle.

Determining the plurality of input signal patterns may include: identifying different input signal patterns based on the number of times that the at least one input signal is repeated within a predetermined time period.

According to one or more example embodiments of the present disclosure, an apparatus of a vehicle may include: a processor; and a memory storing at least one instruction. The at least one instruction may be configured, when executed by the processor communicating with the memory, to cause the apparatus to: receive, via a first wireless communication with a user terminal associated with the vehicle, a message indicating a key assignment change for a vehicle key associated with the vehicle; based on the key assignment change, transmit, via a second wireless communication with the vehicle key, a signal configure to assign each of a plurality of functions of the vehicle to a corresponding one of a plurality of input signal patterns of a key input of the vehicle; receive, via a third wireless communication with the vehicle key associated with the vehicle, a key input signal associated with the key input; identify an input signal pattern based on at least one of: a number of times that the key input signal is received, an interval of the key input signal, a duration of the key input signal, or a time at which the key input signal is received; and control, based on the input signal pattern, an operation of the vehicle. The operation of the vehicle may include a function of the plurality of functions corresponding to the identified input signal pattern. The key input signal may be generated based on the key input of the vehicle key being activated.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating an apparatus for controlling a vehicle;

FIG. 2 is a diagram illustrating a system including an apparatus for controlling a vehicle;

FIG. 3 is a diagram illustrating an example of matching the operation of a button of a smart key with a function of a vehicle by an apparatus for controlling a vehicle;

FIG. 4 is a flowchart illustrating an apparatus for controlling a vehicle or a method of controlling a vehicle;

FIG. 5 is a flowchart illustrating a process in which a vehicle function is performed according to the operation of a smart key button by an apparatus for controlling a vehicle or a method of controlling a vehicle; and

FIG. 6 is a block diagram illustrating a computing system related to an apparatus for controlling a vehicle or a method of controlling a vehicle.

### DETAILED DESCRIPTION

Hereinafter, one or more example embodiments of the present disclosure will be described in detail with reference to the exemplary drawings. In adding the reference numerals to the components of each drawing, it should be noted that the identical or equivalent component is specified by the identical numeral even if they are displayed on other drawings. Further, in describing the example embodiment of the present disclosure, a detailed description of the related known configuration or function will be omitted if it is determined that it interferes with the understanding of the example embodiment of the present disclosure.

Terms, such as first, second, A, B, (a), (b) or the like may be used herein when describing components of the present disclosure. The terms are provided only to distinguish the elements from other elements, and the essences, sequences, orders, and numbers of the elements are not limited by the terms.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

In addition, unless defined otherwise, all terms used herein, including technical or scientific terms, have the same meanings as those generally understood by those skilled in the art to which the present disclosure pertains. The terms defined in the generally used dictionaries should be construed as having the meanings that coincide with the meanings of the contexts of the related technologies, and should not be construed as ideal or excessively formal meanings unless clearly defined in the specification of the present disclosure.

In at least some implementations, buttons of a smart key are designed with a fixed mapping of functions, making it difficult or impossible for a user to customize the buttons by adding a new function or selecting and changing a function according to personal preferences. Such an implementation may limit the user experience and result in limited functional extensibility.

In addition, due to such a fixed function design, it may be impossible to update the functions of a smart key or provide a new service using over-the-air (OTA) technology. Such an implementation may limit the software-based expandability of a vehicle and fail to meet the increasing demands for customized user functions as technology advances.

Smart keys of some implementations have built-in multi-function buttons, but the multi-function buttons operate in a manner where one button only selects one specific function, making it impossible to operate multiple functions using one button. This reduces the efficiency of button usage and does not satisfy the needs of users who desire to utilize multiple functions simultaneously.

In addition, the function setting of smart keys in at least some implementations are limited to being changed only through an audio, video and navigation (AVN) screen in a vehicle. As a result, the functions of the smart key could not be changed when the user is not inside the vehicle. This may reduce user convenience by preventing a user from adjusting or setting the functions of the smart key as needed from an outside of the vehicle.

The present disclosure will describe a technology for dynamically changing or expanding the functions of a smart key button.

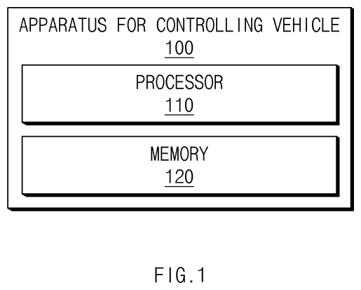

Hereinafter, one or more example embodiments of the present disclosure will be described in detail with reference to FIGS. 1 to 6.

FIG. 1 is a block diagram illustrating an apparatus for controlling a vehicle.

Referring to FIG. 1, an apparatus 100 for controlling a vehicle may be implemented inside the vehicle. In this case, the apparatus 100 for controlling a vehicle may be formed integrally with internal control devices of the vehicle, or may be implemented as a separate device and connected to the control devices of the vehicle via a separate connection device.

The apparatus 100 for controlling a vehicle may include a processor 110 and a memory 120. The configuration of the apparatus 100 for controlling a vehicle shown in FIG. 1 is illustrative, and the present disclosure is not limited thereto. For example, the apparatus 100 for controlling a vehicle may further include components not shown in FIG. 1.

The memory 120 may store commands or data. For example, the memory 120 may store one or more instructions that, if executed by the processor 110, allow the apparatus 100 for controlling a vehicle to perform various operations.

The memory 120 and the processor 110 may be implemented as a single chipset or multiple chipsets. The memory 120 may store various information related to the apparatus 100 for controlling a vehicle. For example, the memory 120 may store information about the operation history of the processor 110.

The memory 120 may include a non-volatile memory (e.g., a read-only memory: ROM) and a volatile memory (e.g., a random access memory: RAM). For example, information about a vehicle function that matches an input signal pattern identified through a single button included in a smart key may be stored in the memory 120.

The processor 110 may receive at least one input signal generated through a button on a smart key.

A smart key may be in the form of a key fob. For example, the smart key may include a device that is capable of wirelessly communicating with a vehicle to perform various functions. The smart key may perform functions such as locking or unlocking of vehicle doors, opening or closing of a trunk, and remote starting.

The smart key may communicate with a vehicle by using wireless communication technology. For example, the smart key may exchange signals with a vehicle through radio frequency identification (RFID), a radio frequency (RF), near-field communication (NFC), Bluetooth, or ultra-wideband (UWB) technology.

The smart key may include at least one button. For example, the smart key may include one or more of a general button used to perform only one function, a multi-functional button used to perform multiple functions, or any combination thereof.

A button of the smart key may be designed in various shapes to detect a user input. For example, the smart key may include a button that is physically pressed (e.g., depressed) or a button that senses an electrical signal.

At least one input signal may be generated by a button of the smart key when pressed or activated. If a user presses or activates a button on the smart key, the smart key may generate a signal in response to the operation of the button. The signal may include identification information (e.g., a unique identification) that indicates which button has been pressed. The signal generated by the smart key may be transmitted to the apparatus 100 for controlling a vehicle through wireless communication.

The processor 110 may identify at least one of the number (e.g., quantity) of times of at least one input signal, the interval of the at least one input signal, the duration of the at least one input signal, or the time at which the at least one input signal is received, or any combination thereof.

For example, the processor 110 may identify the number of times of input signals received within a specified time period. As a specific example, if a button of the smart key is pressed three times within a specified time period, the processor 110 may identify the input signal three times within the specified time period.

For example, if receiving a plurality of input signals, the processor 110 may identify the interval between the plurality of input signals. The interval between the plurality of input signals may be identified in time units. As a specific example, if the button of the smart key is pressed twice having a 1-second interval, the processor 110 may identify the interval between the two input signals as 1 second.

For example, the processor 110 may identify the duration of an input signal. As a specific example, if a button of the smart key pressed and held, the processor 110 may identify the duration of an input signal received while the smart key is held pressed.

For example, the processor 110 may identify the time at which the input signal is received. As a specific example, the processor 110 may identify the time at which the input signal is received and determine the time duration for which the button of the smart key is pressed and held.

The processor 110 may identify a plurality of input signal patterns based on at least one of the number of times of at least one input signal, the interval of the at least one input signal, the duration of the at least one input signal, the time at which the at least one input signal is received, or any combination thereof.

The input signal pattern may include a series of regular (e.g., periodic) operation sequences or irregular (e.g., non-periodic) operation sequences determined based on a feature of an input signal generated from the smart key.

The processor 110 may identify an input signal pattern determined based on at least one of the number of times of an input signal, the interval between input signals, the duration of the input signal, the time at which the input signal is received, or any combination thereof. The input signal pattern may be determined by the audio, video, and navigation (AVN) system (also referred to as a user interface) of a vehicle, the terminal (e.g., a smartphone) of a user (also referred to as a user terminal), the infotainment system of the vehicle, an external server communicating with the vehicle, and/or a system.

For example, the input signal pattern may be determined based on the number of times the input signal is transmitted. For example, the input signal pattern may be determined as a different pattern based on the manner in which the button of the smart key is pressed once, twice, or three times consecutively.

The input signal pattern may be determined based on the interval between input signals. That is, the pattern of the input signal may be determined based on the time interval between a plurality of consecutive input signals. For example, if the plurality of input signals are repeated at short intervals (e.g., within 0.5 seconds of each other), the plurality of input signals may be identified as one input signal pattern. If the plurality of input signals are repeated at long intervals (e.g., 1 second or more from each other), each input signal included in the plurality of input signals may be identified as input signal patterns different from each other (e.g., separate signals).

The input signal pattern may be determined based on the duration of an input signal. For example, an input signal lasting for less than 0.5 seconds and an input signal lasting for more than 0.5 seconds may be identified as different input signal patterns.

The input signal pattern may be determined based on the time at which an input signal is received. For example, even if the input signals are the same otherwise, the input signal received in the morning and the input signal received in the afternoon may be identified as different input signal patterns, thus mapping to different commands or functions. The time at which the input signal is received may be set to a specific time range.

The input signal pattern may be determined based on a combination of the number of the input signals, the interval between the input signals, the duration of the input signals, or the time at which the input signals are received. For example, a pattern of pressing the button on a smart key twice consecutively, holding it for a certain period of time, and then pressing it once more may be identified as one input signal pattern.

The processor 110 may control the vehicle based on the plurality of input signal patterns. For example, the processor 110 may perform a vehicle function corresponding to each of the plurality of input signal patterns. For example, if the user presses the button on the smart key once within a specified time period, the processor 110 may turn on the headlights of the vehicle. As another example, if the user presses the button on the smart key twice consecutively within a specified time period, the processor 110 may perform a panic function (e.g., repeatedly activating the horn) of the vehicle.

The processor 110 may match different functions of the vehicle to each of the plurality of input signal patterns. For example, a short input signal pattern may be matched with a door lock/unlock function of the vehicle, while a long input signal pattern may be matched with a remote start function.

The processor 110 may match (e.g., assign) an input signal pattern with a specific function of the vehicle based on at least one of a default value associated with matching, a user setting, a preset (e.g., predetermined) matching (e.g., assignment) rule, or any combination thereof. Accordingly, a user may control various functions of a vehicle by using a single button on a smart key.

However, this is only an example, and two or more input signal patterns may be matched with (e.g., assigned to) the same function of the vehicle by the user or the system. In this case, there may be two or more schemes of performing the function of the corresponding vehicle.

The set matching rule may be stored in the memory of the vehicle, so that the existing settings may be maintained even if the vehicle is restarted or a smart key is newly registered (e.g. paired with the vehicle).

The processor 110 may receive information about matching (e.g., button assignments) from at least one of the AVN system of the vehicle, the terminal of the user, the infotainment system of the vehicle, the external server communicating with the vehicle, or any combination thereof.

The AVN system of the vehicle may include a system that comprehensively manages main information and entertainment functions inside the vehicle. For example, the AVN system may include a display screen and/or a touchscreen interface located on the dashboard of the vehicle and may perform various functions, such as displaying vehicle status information, providing navigation route guidance, performing audio and video playback, and the like.

The terminal of a user may include a smartphone, tablet, or other smart device, and may be remotely connected to the vehicle to control vehicle functions. The terminal of the user may support checking the vehicle's status, remote control, and changing settings (e.g., reassigning button assignments) through an application.

The infotainment system of a vehicle may be responsible for entertainment or information management functions of the vehicle. The infotainment system may be integrated with the AVN system or may be operated as a separate interface. The infotainment system may provide audio playback, media streaming, voice command control, Bluetooth connectivity, in-vehicle Internet services, or the like.

An external server communicating with a vehicle may include a cloud-based data management system remotely connected to the vehicle. The external server may perform remote control and function updates of the vehicle. For example, the external server may remotely update software related to the vehicle or settings related to a smart key through an over-the-air (OTA) update.

The AVN system of the vehicle, the terminal of the user, the infotainment system of the vehicle, or an external server communicating with the vehicle may serve as an input device for matching the smart key and the functions of the vehicle, or may also serve as an output device for displaying the matching result for the user.

Information about matching may include at least one of information about a defined input signal pattern, information about a function of a vehicle that may be controlled by a smart key, information about matching between an input signal pattern and a function of the vehicle, a default value related to matching, a matching rule set by a user, a preset (e.g., predetermined) matching (e.g., assignment) rule, or any combination thereof.

The processor 110 may match (e.g., assign) different functions of the vehicle to each of a plurality of input signal patterns based on information about matching (e.g., assignment).

The processor 110 may change (e.g., reassign) different functions of a vehicle matched (e.g., assigned) to each of a plurality of input signal patterns based on information about matching (e.g., assignment).

For example, if a user sets a specific input signal pattern to be matched with a specific function of a vehicle through a smartphone application, the processor 110 may receive information about corresponding matching and update a matching rule between the input signal pattern and the function of the vehicle.

For example, a user may set the door lock/unlock function of the vehicle to match a “single press” input signal pattern and the remote start function to match a “double press” input signal pattern through a smartphone application. In this case, if the set matching information is transmitted to the processor 110 through the communication module (also referred to as a communication interface) of the vehicle, the processor 110 may update an existing matching rule between the input signal pattern and the function of the vehicle or apply a new matching (e.g., assignment) rule based on the corresponding information.

As another example, the processor 110 may manually set (e.g., defined) matching (e.g., assignment) rules through an internal vehicle system, such as the infotainment system or AVN system of the vehicle. For example, a user may access a settings menu through the display screen of the vehicle and directly change matching rules between input signal patterns and functions. If such a setting is complete, the processor 110 may store the corresponding matching rule and control the vehicle such that the matched function of the vehicle is executed whenever an input signal pattern is identified.

As still another example, matching rules may be updated remotely through an over-the-air (OTA) update from an external server of the vehicle manufacturer. For example, if a new function is added to a vehicle or an existing function is improved, an external server of the manufacturer may transmit updated information to the vehicle. The processor 110 may receive the updated information and automatically update matching rules between input signal patterns and vehicle functions.

The processor 110 may receive information about matching through at least one of a communication module that wirelessly relays data on a vehicle, a gateway module (also referred to as a gateway or a network gateway) that routes the data about the vehicle, or any combination thereof.

A system including an apparatus for controlling a vehicle may include a communication module for wirelessly relaying data on the vehicle, and a gateway module for routing the data on the vehicle.

A communication module for wirelessly relaying the data on the vehicle may include a relay for transmitting or receiving the data. The communication module may include various wireless communication devices that support bidirectional communication with networks inside and outside the vehicle. For example, the communication module may support wireless communication protocols, such as cellular networks (e.g., Long-Term Evolution (LTE), 5G New Radio (NR)), Wi-Fi, Bluetooth, ultra-wideband (UWB), and near-field communication (NFC), and the like, to transmit and receive data between the vehicle and an external server, a smartphone of a user, and other apparatus for controlling a vehicles.

For example, the communications module may include a data connectivity unit (DCU). As a specific example, the data connectivity unit (DCU), which is a device that manages communication between a vehicle and an external system, may perform functions such as software updates, remote diagnostics, and real-time vehicle status reporting by communicating with the external server. The DCU may include, for example, a modem, an antenna, a transmitter, a receiver, a transceiver, etc.

The gateway module for routing data on a vehicle may include a central communication unit (CCU).

For example, the gateway module may serve as a network hub of a vehicle and be connected to various devices such as an electronic control unit (ECU), a sensor, a communication module, an infotainment systems, an AVN systems, and the like in the vehicle.

As a specific example, if a user sets a specific input signal pattern to be matched with a vehicle function through a smartphone application, the corresponding setting information may be transmitted from an external server to a gateway module through a communication module. The gateway module may route the received data to the processor 110 such that the application for controlling a vehicle updates the matching of an input signal pattern with a vehicle function.

In addition, the gateway module may collect and store information about matching. As a specific example, information about matching set through the AVN system or infotainment system may be transmitted to the processor 110 through the gateway module. If a user changes the information about matching, the changed information may be reflected throughout the system.

The processor 110 may activate or deactivate a state in which a first function of the vehicle is matched to a first input signal pattern included in a plurality of input signal patterns. For example, an input signal pattern of double-pressing a smart key button may be matched with a panic function of a vehicle. In this case, a user may activate or deactivate the matching state between the input signal pattern and the panic function of the vehicle through the smartphone application.

A user may use a check box related to the matching state in a setting screen of the smartphone application. If the check marked in the checkbox is activated, the matching between the input signal pattern and the panic function of the vehicle may be activated. If the check mark is unchecked, the matching state may be deactivated. Thus, a user may easily manage the matching between the input signal pattern of the smart key button and the vehicle function, and change the function settings as needed.

The processor 110 may perform the first function based on the activation of a state in which the first input signal pattern and the first function are matched. In addition, the processor 110 may not perform the first function even if the first input signal pattern is identified based on the state in which the first input signal pattern and the first function are matched being deactivated.

For example, the processor 110 may check in real time whether the matching state is activated and perform a vehicle function according to the corresponding state whenever an input signal pattern is identified.

As a specific example, if a user activates a matching state between an input signal pattern of pressing a smart key button twice consecutively and a panic function of a vehicle through a smartphone application, if the user presses the smart key button twice consecutively, a warning light of a vehicle may be turned on, a horn may sound, and the panic function may be performed.

To the contrary, if a user deactivates the matching state, the processor 110 may not perform the panic function of the vehicle even if an input signal pattern of pressing the smart key button twice consecutively is identified.

The processor 110 may control a function of a vehicle based on a plurality of input signal patterns and update a type of function of the vehicle through a software update.

The processor 110 may reflect the settings related to the matching between the input signal pattern and the vehicle function whenever they are updated.

For example, if a matching (e.g., assignment) between a new input signal pattern and a vehicle function is added through an OTA update, the processor 110 may receive the updated information corresponding thereto and register a new matching rule or modify an existing matching rule. Accordingly, the processor 110 may increase user convenience by reflecting user preferences and the latest software updates in the system.

The processor 110 may perform the second function of the vehicle that matches the second input signal pattern based on identifying the second input signal pattern included in the plurality of input signal patterns. In addition, the processor 110 may return to the state before performing the second function based on re-identifying the second input signal pattern after the second function is performed.

For example, if the second input signal pattern in which a user presses a button of the smart key three times consecutively matches the remote start function of the vehicle, the processor 110 may identify the corresponding signal pattern and perform remote start of the vehicle at the same time. In addition, if the user presses the smart key button three times consecutively again while remote start is already activated, the processor 110 may identify the same second input signal pattern and stop the engine of the vehicle to return the vehicle to the state before the remote start is performed.

The processor 110 may control a function related to at least one of a vehicle door, a vehicle start, a vehicle air conditioning system, a vehicle lighting, a vehicle security, a vehicle parking, a vehicle seat, a vehicle alarm, a vehicle charging, a vehicle multimedia system, or any combination thereof, based on the plurality of input signal patterns.

That is, the vehicle function matching the input signal pattern may include at least one of the vehicle door, the vehicle start, the vehicle air conditioning system, the vehicle lighting, the vehicle security, the vehicle parking, the vehicle seat, the vehicle alarm, the vehicle charging, the vehicle multimedia system, or any combination thereof.

The processor 110 may identify different input signal patterns based on the number of times at least one input signal is repeated within a preset (e.g., predetermined) time period. For example, if a button on a smart key is pressed twice consecutively within a preset (e.g., predetermined) time (e.g., 2 seconds), it may be identified as the first input signal pattern and the door lock/unlock function of the vehicle may be performed. If the button on the smart key is pressed three times consecutively within a preset (e.g., predetermined) time (e.g. 2 seconds), it may be identified as the second input signal pattern, and the emergency warning light flashing function of the vehicle may be performed.

The processor 110 may control the vehicle with a preset (e.g., predetermined) priority based on identifying overlapping signal patterns among the plurality of input signal patterns.

For example, if a specific input signal pattern includes another input signal pattern, the two input signal patterns may overlap, which may cause confusion. Thus, the processor 110 may accurately identify (e.g., determine) the input signal pattern based on the order in which the input signal occurs within a preset (e.g., predetermined) time range, or the number of times the input signal is repeated within a preset (e.g., predetermined) time range (e.g., time period).

For example, the first input signal pattern of pressing a button on the smart key three times consecutively may include the second input signal pattern of pressing the button on the smart key twice consecutively. In this case, confusion may occur as the first input signal pattern and the second input signal pattern overlap. Therefore, the processor 110 may identify the input signal pattern according to the input signal identified within a preset (e.g., predetermined) time period.

The processor 110 may apply a preset (e.g., predetermined) time range or a rule for identifying input signal patterns to prevent duplication between input signal patterns and to accurately identify them. If the first input signal is detected, the processor may identify a specific input signal pattern by accumulating the number of times the input signal is received during a preset (e.g., predetermined) time period (e.g., 2 or 3 seconds). If the preset (e.g., predetermined) time period expires, the final input signal pattern is determined based on the number of times the input signal is received, and then received input signals may be used to identify new input signal patterns.

The processor 110 may apply a rule that preferentially identifies long input signal patterns to prevent duplication of an input signal pattern. For example, if a user presses a smart key button three times consecutively, the processor 110 may temporarily identify two consecutive presses as an input signal pattern, but if a third input signal is received, the processor 110 may finally identify it as an input signal pattern of three consecutive presses. In such a manner, an error in which short input signal patterns are incorrectly identified contrary to the user's intention may be prevented.

The processor 110 may apply a rule to prevent an error. For example, if the interval between input signals exceeds a preset (e.g., predetermined) time interval or the number of times of an input signal exceeds a preset (e.g., predetermined) number of times, the corresponding input signal pattern may be ignored or reset to an initial state.

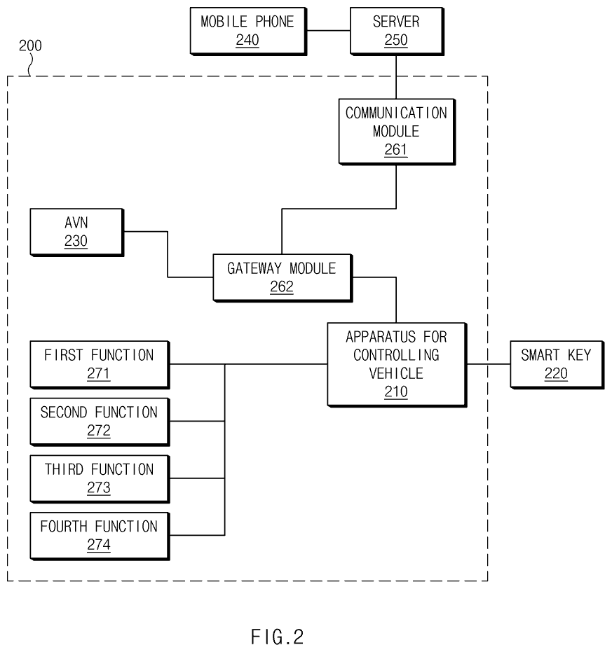

FIG. 2 is a diagram illustrating a system including an apparatus for controlling a vehicle.

A system 200 including an apparatus for controlling a vehicle may include at least one of an apparatus 210 for controlling a vehicle, an AVN system 230, a communication module 261, a gateway module 262, or any combination thereof. In addition, the apparatus 210 for controlling a vehicle may perform various functions of the vehicle by operation of a smart key.

For example, the various functions of the vehicle may include at least one of a first function 271, a second function 272, a third function 273, a fourth function 274, or any combination thereof. The various functions of the vehicle may be added or changed by operation of the smart key of the vehicle.

The system 200 including an apparatus for controlling a vehicle may exchange data with at least one of a smart key 220 of the vehicle, a mobile phone 240, a server 250, or any combination thereof. In this case, the system 200 including an apparatus for controlling a vehicle may utilize wireless communication.

The apparatus 210 for controlling a vehicle may include a body domain controller (BDC).

The smart key 220 may include a multi-function button capable of controlling various functions of the vehicle with a single button.

A user may set a function of the vehicle to be controlled by the multi-function button of the smart key 220 through the AVN system 230. Information set by the user may be transmitted to the apparatus 210 for controlling a vehicle through the AVN system 230.

A user may set a function of the vehicle to be controlled by the multi-function button of the smart key 220 not only through the AVN system 230 but also through the mobile phone 240. In this case, information set in the mobile phone 240 may be transmitted to the apparatus 210 for controlling a vehicle through the server 250. In detail, the information set in the mobile phone 240 may be finally transmitted to the apparatus 210 for controlling a vehicle through the server 250, the communication module 261 of the vehicle, and the gateway module 262.

A user may control different vehicle functions in such a manner that the multi-function button of the smart key 220 is pressed. For example, if a user briefly presses the multi-function button once, the first function 271 of the vehicle may be performed. If a user presses the multi-function button twice consecutively, the second function 272 of the vehicle may be performed. If a user presses the multi-function button three times consecutively, the third function 273 of the vehicle may be performed. If a user presses the multi-function button four times consecutively, the fourth function 274 of the vehicle may be performed.

The functions of a vehicle that are to be controlled by a multi-function button may be updated through a software update. For example, the apparatus 210 for controlling a vehicle may add or change the functions of the vehicle through OTA.

Referring to FIG. 2, the system 200 including an apparatus for controlling a vehicle may improve the convenience and efficiency of controlling a vehicle function by using a smart key through identification and management functions of various input signal patterns and real-time updates.

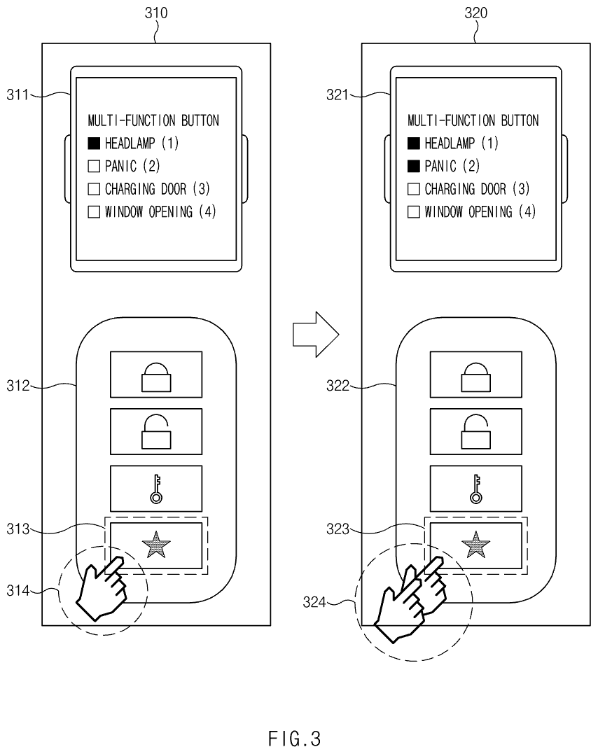

FIG. 3 is a diagram illustrating an example of matching the operation of a button of a smart key with a function of a vehicle by an apparatus for controlling a vehicle.

FIG. 3 illustrates an example in which a vehicle is controlled depending on whether a multi-function button 313 of a smart key 312 is pressed once 310 or whether a multi-function button 323 of a smart key 322 is pressed twice 320.

For example, depending on the number of times the multi-function button 313 of the smart key 312 is pressed, the headlamps, panic, a charging door (also referred to as a charger port door), or window opening functions of the vehicle may be performed.

In detail, a user may match an operation 314 of pressing the multi-function button 313 once with the headlamp function of the vehicle. In this case, if the multi-function button 313 is pressed once, the headlamp of the vehicle may be turned on.

In detail, a user may match an operation 324 of pressing the multi-function button 323 twice with the panic function of the vehicle. In this case, if the multi-function button 323 is pressed twice, the panic function may be performed in which the warning lights of the vehicle is turned on and the horn sounds.

The operation 314 of pressing the multi-function button 313 once may be matched with (e.g., assigned to) the headlamp function of the vehicle (e.g., first matching or assignment), the operation 324 of pressing the multi-function button 323 twice may be matched with the panic function of the vehicle (e.g., second matching or assignment), an operation of pressing the multi-function button 323 three times may be matched with the charging door function (e.g., third matching or assignment), and an operation of pressing the multi-function button 323 four times may be matched with the window opening function of the vehicle (e.g., fourth matching or assignment).

A user may activate or deactivate at least one of the first matching, the second matching, the third matching, the fourth matching, or any combination thereof. For example, a user may activate the corresponding matching by adding a mark to a checkbox for a vehicle function in response to the operation of the multi-function button 313. To the contrary, a user may deactivate the corresponding match by unchecking the checkbox.

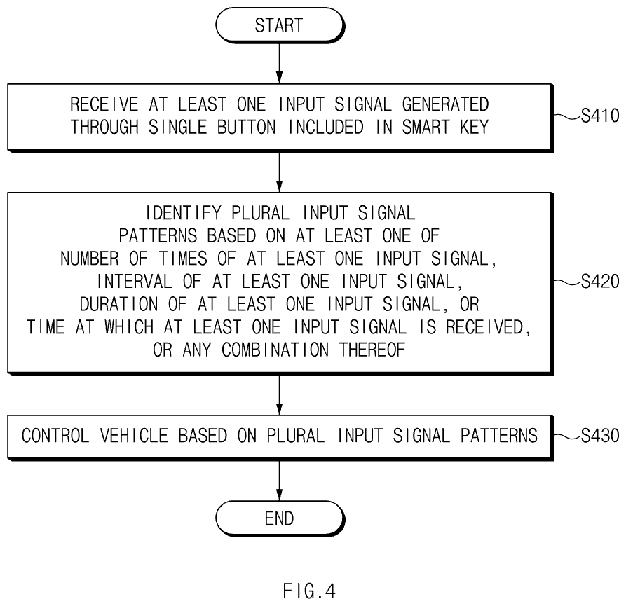

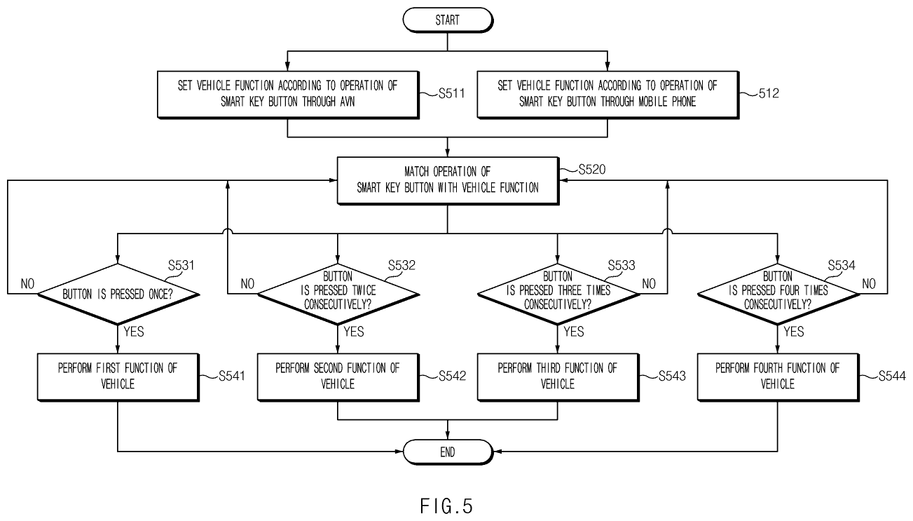

Hereinafter, an apparatus for controlling a vehicle or a method of controlling a vehicle will be described in detail with reference to FIGS. 4 and 5.

Hereinafter, the apparatus 100 for controlling a vehicle of FIG. 1 may perform the process of FIG. 4 or FIG. 5. In addition, in the description of FIG. 4 or FIG. 5, the operation described as being performed by the apparatus for controlling a vehicle may be understood to be controlled by the processor 110 of the apparatus 100 for controlling a vehicle.

FIG. 4 is a flowchart illustrating an apparatus for controlling a vehicle or a method of controlling a vehicle.

In S410, an apparatus for controlling a vehicle may receive at least one input signal generated through a single button included in a smart key.

In S420, the apparatus for controlling a vehicle may identify a plurality of input signal patterns based on at least one of the number of times of at least one input signal, the interval of the at least one input signal, the duration of the at least one input signal, the time at which the at least one input signal is received, or any combination thereof.

In S430, the apparatus for controlling a vehicle may control the vehicle based on a plurality of input signal patterns.

Referring to FIG. 4, the apparatus for controlling a vehicle may receive an input signal generated from a single button of a smart key, and identify a plurality of input signal patterns based on features (e.g., number of times, interval, duration, and the like) of the input signal, thereby controlling the vehicle.

FIG. 5 is a flowchart illustrating a process in which a vehicle function is performed according to the operation of a smart key button by an apparatus for controlling a vehicle or a method of controlling a vehicle.

In S511, a user may set a vehicle function according to the operation of a button on a smart key through an AVN. In addition, in S512, the user may set the function of the vehicle according to the operation of the button of the smart key through the mobile phone.

The button of the smart key may include a multi-function button capable of performing various functions of the vehicle with a single button.

In S520, the apparatus for controlling a vehicle may match the operation of the button of the smart key with the function of the vehicle. For example, the user may match the operation of the button on the smart key with the vehicle function by using the AVN or the mobile phone. The matched information may be transmitted to the apparatus for controlling a vehicle. The apparatus for controlling a vehicle may perform the function of the vehicle based on the matched information.

For example, if the user presses the button on the smart key, an input signal may be generated according to the operation of the button on the smart key. The apparatus for controlling a vehicle may identify the input signal pattern based on the input signal received from the smart key. The apparatus for controlling a vehicle may match the function of the vehicle to each input signal pattern. The apparatus for controlling a vehicle may perform the function of the vehicle matched with the input signal pattern.

If the button of the smart key is pressed once in S531, in S541, the first function of the vehicle may be performed. For example, the apparatus for controlling a vehicle may identify the first input signal pattern according to the single press of the button on the smart key. Then, the apparatus for controlling a vehicle may perform the first function of the vehicle matched with the first input signal pattern.

If the button of the smart key is pressed twice in S532, the second function of the vehicle may be performed in S542. For example, the apparatus for controlling a vehicle may identify the second input signal pattern corresponding to the operation of pressing the button on the smart key twice. Then, the apparatus for controlling a vehicle may perform the second function of the vehicle matched with the second input signal pattern.

If the button of the smart key is pressed three times in S533, the third function of the vehicle may be performed in S543. For example, the apparatus for controlling a vehicle may identify the third input signal pattern corresponding to the operation of pressing the button on the smart key three times. Then, the apparatus for controlling a vehicle may perform the third function of the vehicle matched with the third input signal pattern.

If the button of the smart key is pressed four times in S534, the fourth function of the vehicle may be performed in S544. For example, the apparatus for controlling a vehicle may identify the fourth input signal pattern corresponding to the operation of pressing the button on the smart key four times. Then, the apparatus for controlling a vehicle may perform the fourth function of the vehicle matched with the fourth input signal pattern.

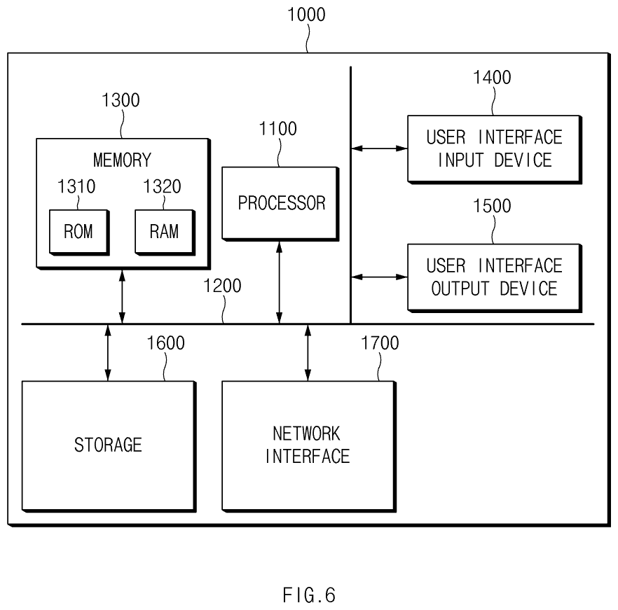

FIG. 6 is a block diagram illustrating a computing system related to an apparatus for controlling a vehicle or a method of controlling a vehicle.

Referring to FIG. 6, a computing system 1000 may include at least one processor 1100, a memory 1300, a user interface input device 1400, a user interface output device 1500, storage 1600, and a network interface 1700 which are connected through a bus 1200.

The processor 1100 may be a central processing unit (CPU) or a semiconductor device that processes instructions stored in the memory 1300 and/or the storage 1600. The memory 1300 and the storage 1600 may include various volatile or nonvolatile storage media. For example, the memory 1300 may include a read only memory (ROM) 1310 and a random access memory (RAM) 1320.

Accordingly, the processes of the method or algorithm described herein may be implemented directly by hardware executed by the processor 1100, a software module, or any combination thereof. The software module may reside in a storage medium (that is, the memory 1300 and/or the storage 1600), such as a RAM, a flash memory, a ROM, an erasable programmable read-only memory (EPROM), an electrically erasable programmable read-only memory (EEPROM), a register, a hard disk, a detachable disk, or a compact disc read-only memory (CD-ROM).

The exemplary storage medium is coupled to the processor 1100, and the processor 1100 may read information from the storage medium and may write information in the storage medium. In another method, the storage medium may be integrated with the processor 1100. The processor 1100 and the storage medium may reside in an application specific integrated circuit (ASIC). The ASIC may reside in a user terminal. In another method, the processor and the storage medium may reside in the user terminal as an individual component.

According to one aspect of the present disclosure, an apparatus for controlling a vehicle includes a memory that stores a program instruction, and a processor that executes the program instruction, wherein the processor receives at least one input signal generated through a single button included in a smart key, identifies a plurality of input signal patterns based on at least one of a number of times of the at least one input signal, an interval of the at least one input signal, a duration of the at least one input signal, or time at which the at least one input signal is received, or any combination thereof, and controls the vehicle based on the plurality of input signal patterns.

The processor may match different functions of the vehicle to each of the plurality of input signal patterns.

The processor may receive information about the matching from at least one of an audio, video and navigation (AVN) system of the vehicle, a terminal of a user, an infotainment system of the vehicle, or an external server communicating with the vehicle, or any combination thereof, and match different functions of the vehicle to each of the plurality of input signal patterns based on the information about the matching, or change different functions of the vehicle matched to each of the plurality of input signal patterns based on the information about the matching.

The processor may receive the information about the matching through at least one of a communication module for wirelessly relaying data on the vehicle, or a gateway module for routing the data on the vehicle, or any combination thereof.

The processor may activate or deactivate a state in which a first function of the vehicle is matched to a first input signal pattern included in the plurality of input signal patterns, and execute the first function based on the state in which the first input signal pattern and the first function are matched being activated, or allow the first function not to be executed even if the first input signal pattern is identified based on the state in which the first input signal pattern and the first function are matched being deactivated.

The processor may control a function of the vehicle based on the plurality of input signal patterns, and update a type of a functions of the vehicle through a software update.

The processor may execute a second function of the vehicle that matches a second input signal pattern based on identifying the second input signal pattern included in the plurality of input signal patterns, and return to a state before executing the second function based on re-identifying the second input signal pattern after the second function is executed.

The processor may control a function related to at least one of a door of the vehicle, an ignition of the vehicle, an air conditioning system of the vehicle, lighting of the vehicle, security of the vehicle, parking of the vehicle, a seat of the vehicle, an alarm of the vehicle, charging of the vehicle, or a multimedia system of the vehicle, or any combination thereof, based on the plurality of input signal patterns.

The processor may identify different input signal patterns based on a number of times the at least one input signal is repeated within a preset time.

The processor may control the vehicle with a preset priority based on identifying an overlapping signal pattern among the plurality of input signal patterns.

According to another aspect of the present disclosure, a method of controlling a vehicle includes receiving, by a processor, at least one input signal generated through a single button included in a smart key, identifying, by the processor, a plurality of input signal patterns based on at least one of a number of times of the at least one input signal, an interval of the at least one input signal, a duration of the at least one input signal, or time at which the at least one input signal is received, or any combination thereof, and controlling, by the processor, the vehicle based on the plurality of input signal patterns.

The method may further include matching, by the processor, different functions of the vehicle to each of the plurality of input signal patterns.

The matching of the different functions of the vehicle to each of the plurality of input signal patterns may include matching, by the processor, different functions of the vehicle to each of the plurality of input signal patterns based on information about the matching received from at least one of an audio, video and navigation (AVN) system of the vehicle, a terminal of a user, an infotainment system of the vehicle, or an external server communicating with the vehicle, or any combination thereof, or changing, by the processor, different functions of the vehicle matched to each of the plurality of input signal patterns based on information about the matching received from at least one of an audio, video and navigation (AVN) system of the vehicle, a terminal of a user, an infotainment system of the vehicle, or an external server communicating with the vehicle, or any combination thereof.

The matching of the different functions of the vehicle to each of the plurality of input signal patterns may include receiving, by the processor, the information about the matching through at least one of a communication module for wirelessly relaying data on the vehicle, or a gateway module for routing the data on the vehicle, or any combination thereof.

The method may further include activating or deactivating, by the processor, a state in which a first function of the vehicle is matched to a first input signal pattern included in the plurality of input signal patterns, wherein the controlling of the vehicle includes executing, by the processor, the first function based on the state in which the first input signal pattern and the first function are matched being activated, or allowing, by the processor, the first function not to be executed even if the first input signal pattern is identified based on the state in which the first input signal pattern and the first function are matched being deactivated.

The method may further include updating, by the processor, a type of a functions of the vehicle controlled based on the plurality of input signal patterns through a software update.

The controlling of the vehicle may include executing, by the processor, a second function of the vehicle that matches a second input signal pattern based on identifying the second input signal pattern included in the plurality of input signal patterns, and returning, by the processor, to a state before executing the second function based on re-identifying the second input signal pattern after the second function is executed.

The controlling of the vehicle may include controlling, by the processor, a function related to at least one of a door of the vehicle, an ignition of the vehicle, an air conditioning system of the vehicle, lighting of the vehicle, security of the vehicle, parking of the vehicle, a seat of the vehicle, an alarm of the vehicle, charging of the vehicle, or a multimedia system of the vehicle, or any combination thereof, based on the plurality of input signal patterns.

The identifying of the plurality of input signal patterns may include identifying, by the processor, different input signal patterns based on a number of times the at least one input signal is repeated within a preset time.

The controlling of the vehicle may include controlling, by the processor, the vehicle with a preset priority based on identifying an overlapping signal pattern among the plurality of input signal patterns.

According to the present technology, by performing various functions of a vehicle with a single multi-function button of a smart key, it is possible to remove the constraints of the physical space of the button and reduce the size and weight of the smart key.

In addition, according to the present technology, it is possible to expand or change the functions of the multi-function button through over-the-air (OTA) updates.

In addition, according to the present technology, the user experience and marketability may be improved by freely selecting or setting the function of the multi-function button according to the user's preference.

In addition, according to the present technology, different functions may be set to be performed depending on various manners in which the multi-function button is operated, thereby effectively increasing the number of functions that are executed by the multi-function button.

In addition, according to the present technology, it is possible to improve the convenience of the user by setting or changing the functions of the multi-function button through the terminal of the user.

In addition, various effects that are directly or indirectly understood through the present disclosure may be provided.

Although one or more example embodiments of the present disclosure have been described for illustrative purposes, those skilled in the art will appreciate that various modifications, additions and substitutions are possible, without departing from the scope and spirit of the disclosure.

Therefore, the example embodiments disclosed in the present disclosure are provided for the sake of descriptions, not limiting the technical concepts of the present disclosure, and it should be understood that such example embodiments are not intended to limit the scope of the technical concepts of the present disclosure. The protection scope of the present disclosure should be understood by the claims below, and all the technical concepts within the equivalent scopes should be interpreted to be within the scope of the right of the present disclosure.

What is claimed is:

1. An apparatus of a vehicle, the apparatus comprising:
a processor; and
a memory storing at least one instruction that is configured, when executed by the processor communicating with the memory, to cause the apparatus to:
receive, via a wireless communication with a vehicle key associated with the vehicle, at least one input signal, wherein the at least one input signal is generated based on a button of the vehicle key being activated;
determine a plurality of input signal patterns based on at least one of: a number of times that the at least one input signal is received, an interval of the at least one input signal, a duration of the at least one input signal, or a time at which the at least one input signal is received; and
control, based on the plurality of input signal patterns, the vehicle.

2. The apparatus of claim 1, wherein the at least one instruction is configured, when executed by the processor communicating with the memory, to further cause the apparatus to assign each of a plurality of functions of the vehicle to a corresponding one of the plurality of input signal patterns.

3. The apparatus of claim 1, wherein the at least one instruction is configured, when executed by the processor communicating with the memory, to further cause the apparatus to:
receive assignment information from at least one of: a user interface of the vehicle, a user terminal associated with the vehicle, an infotainment system of the vehicle, or an external server communicating with the vehicle; and
perform, based on the assignment information, at least one of:
assigning each of a plurality of functions of the vehicle to a corresponding one of the plurality of input signal patterns; or
reassigning the plurality of functions of the vehicle.

4. The apparatus of claim 3, wherein the at least one instruction is configured, when executed by the processor communicating with the memory, to cause the apparatus to receive the assignment information by:
receiving the assignment information through at least one of: a communication interface configured to wirelessly relay data on the vehicle, or a gateway configured to route the data on the vehicle.

5. The apparatus of claim 2, wherein the at least one instruction is configured, when executed by the processor communicating with the memory, to cause the apparatus to control the vehicle by:
activating or deactivating an assignment of a first function of the vehicle to a first input signal pattern of the plurality of input signal patterns; and
performing one of:
executing, based on the assignment of the first function to the first input signal pattern being activated, the first function; or
not executing, based on the assignment of the first function to the first input signal pattern being deactivated, the first function.

6. The apparatus of claim 1, wherein the at least one instruction is configured, when executed by the processor communicating with the memory, to cause the apparatus to control the vehicle by:
controlling, based on the plurality of input signal patterns, a function of the vehicle; and
updating, via a software update, a type of the function of the vehicle.

7. The apparatus of claim 1, wherein the at least one instruction is configured, when executed by the processor communicating with the memory, to cause the apparatus to control the vehicle by:
executing, based on determining an input signal pattern of the plurality of input signal patterns at a first time, a function, of the vehicle, that is assigned to the input signal pattern; and
returning, based on determining the input signal pattern at a second time after the first time and after the function is executed, the vehicle to a state before executing the function.

8. The apparatus of claim 1, wherein the at least one instruction is configured, when executed by the processor communicating with the memory, to cause the apparatus to control the vehicle by:
controlling, based on the plurality of input signal patterns, at least one of: a door of the vehicle, an ignition of the vehicle, an air conditioning system of the vehicle, lighting of the vehicle, security of the vehicle, parking of the vehicle, a seat of the vehicle, an alarm of the vehicle, charging of the vehicle, or a multimedia system of the vehicle.

9. The apparatus of claim 1, wherein the at least one instruction is configured, when executed by the processor communicating with the memory, to cause the apparatus to determine the plurality of input signal patterns by:
identifying different input signal patterns based on the number of times that the at least one input signal is repeated within a predetermined time period.

10. The apparatus of claim 1, wherein the at least one instruction is configured, when executed by the processor communicating with the memory, to cause the apparatus to control the vehicle by:
controlling, with a predetermined priority based on identifying overlapping signal patterns among the plurality of input signal patterns, the vehicle.

11. A method performed by an apparatus of a vehicle, the method comprising:
receiving, via a wireless communication with a vehicle key associated with the vehicle, at least one input signal, wherein the at least one input signal is generated based on a button of the vehicle key being activated;
determining a plurality of input signal patterns based on at least one of a number of times that the at least one input signal is received, an interval of the at least one input signal, a duration of the at least one input signal, or a time at which the at least one input signal is received; and
controlling, based on the plurality of input signal patterns, the vehicle.

12. The method of claim 11, further comprising:
assigning each of a plurality of functions of the vehicle to a corresponding one of the plurality of input signal patterns.

13. The method of claim 11, further comprising:
receiving assignment information from at least one of: a user interface of the vehicle, a user terminal associated with the vehicle, an infotainment system of the vehicle, or an external server communicating with the vehicle; and
performing, based on the assignment information, at least one of:
assigning each of a plurality of functions of the vehicle to a corresponding one of the plurality of input signal patterns; or
reassigning the plurality of functions of the vehicle.

14. The method of claim 13, wherein the receiving of the assignment information comprises:
receiving the assignment information through at least one of: a communication interface configured to wirelessly relay data on the vehicle, or a gateway configured to route the data on the vehicle.

15. The method of claim 12, wherein the controlling of the vehicle comprises:
activating or deactivating an assignment of a first function of the vehicle to a first input signal pattern of the plurality of input signal patterns; and
performing one of:
executing, based on the assignment of the first function to the first input signal pattern being activated, the first function; or
not executing, based on the assignment of the first function to the first input signal pattern being deactivated, the first function.

16. The method of claim 11, wherein the controlling of the vehicle comprises:
controlling, based on the plurality of input signal patterns, a function of the vehicle; and
updating, via a software update, a type of the function of the vehicle.

17. The method of claim 11, wherein the controlling of the vehicle comprises:
executing, based on determining an input signal pattern of the plurality of input signal patterns at a first time, a function, of the vehicle, that is assigned to the input signal pattern; and
returning, based on determining the input signal pattern at a second time after the first time and after the function is executed, the vehicle to a state before executing the function.

18. The method of claim 11, wherein the controlling of the vehicle comprises:
controlling, based on the plurality of input signal patterns, at least one of: a door of the vehicle, an ignition of the vehicle, an air conditioning system of the vehicle, lighting of the vehicle, security of the vehicle, parking of the vehicle, a seat of the vehicle, an alarm of the vehicle, charging of the vehicle, or a multimedia system of the vehicle.

19. The method of claim 11, wherein the determining of the plurality of input signal patterns comprises:
identifying different input signal patterns based on the number of times that the at least one input signal is repeated within a predetermined time period.

20. An apparatus of a vehicle, the apparatus comprising:
a processor; and
a memory storing at least one instruction that is configured, when executed by the processor communicating with the memory, to cause the apparatus to:
receive, via a first wireless communication with a user terminal associated with the vehicle, a message indicating a key assignment change for a vehicle key associated with the vehicle;
based on the key assignment change, transmit, via a second wireless communication with the vehicle key, a signal configured to assign each of a plurality of functions of the vehicle to a corresponding one of a plurality of input signal patterns of a key input of the vehicle;
receive, via a third wireless communication with the vehicle key associated with the vehicle, a key input signal associated with the key input, wherein the key input signal is generated based on the key input of the vehicle key being activated;
identify an input signal pattern based on at least one of: a number of times that the key input signal is received, an interval of the key input signal, a duration of the key input signal, or a time at which the key input signal is received; and
control, based on the input signal pattern, an operation of the vehicle, wherein the operation of the vehicle comprises a function of the plurality of functions corresponding to the identified input signal pattern.
